(19) United States
(12) Patent Application Publication
(10) Pub. No.: US 2016/0083263 A1
(43) Pub. Date: Mar. 24, 2016

(54) PREPARATION METHOD FOR METALLIC OXIDE SPHERICAL CASCADE STRUCTURE

(71) Applicant: NANJING UNIVERSITY, Jiangsu (CN)

(72) Inventors: MINGWEI ZHU, NANJING (CN); CHAO WANG, NANJING (CN); ZHI LIU, NANJING (CN); YANFENG CHEN, NANJING (CN)

(21) Appl. No.: 14/891,370

(22) PCT Filed: Apr. 25, 2014
(86) PCT No.: PCT/CN2014/076267

§ 371 Date: Nov. 16, 2015

(30) Foreign Application Priority Data
Jun. 13, 2013 (CN) 201310234696.X

(51) Int. Cl. C01G 49/06; C01F 7/02; C01B 33/12; C01G 23/047; C01G 19/02

(52) U.S. Cl. CPC C01G 49/06; C01G 23/047; C01G 19/02; C01B 33/12; C01F 7/02

(57) ABSTRACT

A preparation method for a metallic oxide micro-nano spherical cascade structure, belonging to the field of nanometer/micrometer microstructure material and a preparation thereof is provided. The metallic oxide spherical cascade structure of the present invention refers to a micron-sized spherical particle structure composed of metallic oxide powder having a particle size of tens of nanometers. The preparation method is as follows: uniformly mixing the metallic oxide powder and polyethylene glycol by ball-milling to obtain mixed powder of the metallic oxide and the polyethylene glycol; preparing slurry from the resulting powder, stirring uniformly, and then drying the slurry to obtain a film or bulk on a substrate; and removing by calcining organic compounds to obtain a film or bulk of the metallic oxide spherical cascade structure.

### CROSS-REFERENCE TO RELATED APPLICATIONS

This application claims priority to PCT Application No. PCT/CN2014/076267, having a filing date of Apr. 25, 2014, based off of Chinese Application No. 201310234696.X, having a filing date of Jun. 13, 2013, the entire contents of which are hereby incorporated by reference.

### FIELD OF TECHNOLOGY

The following invention relates to a preparation method for a metallic oxide micro-nano spherical cascade structure, belonging to the field of nanometer/micrometer microstructure material and a preparation thereof.

### BACKGROUND

The preparation for a metallic oxide spherical cascade structure is a technology having important application background. For example, a TiO₂ spherical cascade structure, due to good photocatalysis performance and good capacity of absorbing ultraviolet rays, has been widely applied to aspects such as air purification, sewage treatment, easy-cleaning glass, nano environmentally friendly coatings, functional textiles, plastics, ceramics and thin film solar cells, and has played an important role in aspects such as environmental purification and pollution abatement. A surface microstructure of the metallic oxide spherical cascade structure has important scientific research value and great application prospect as well. For example, a spherical TiO₂, due to its large specific surface area, may improve the efficiency of light collection to a large extent, thereby significantly influencing the fields of photocatalysis and photoelectricity; and SnO₂ having a spherical cascade structure, due to its good sensing property and high sensitivity of gas-sensitive sensors, may be applied to semiconductor sensors.

At present, the metallic oxide spherical cascade structure is mainly a large nanometer/micrometer sphere composed of some nano-particles. The main preparation methods thereof mainly include hydro-thermal synthesis, hydrolysis, vacuum evaporation or atomic beam deposition, etc. However, the hydro-thermal synthesis and the hydrolysis have complex steps, and are time consuming and low in yield with pollution to the environment; the atomic beam deposition is high in cost; and all those methods, it is difficult to control the size of the spherical cascade structure.

### SUMMARY

An aspect relates to a preparation method for a metallic oxide spherical cascade structure which is easy in implementation and low in cost, and can control the size of the structure well.

The metallic oxide spherical cascade structure of embodiments of the present invention are such that micron-sized spheres are composed of many nano-particles, and an entire film and bulk is composed of these micron-sized spheres. The preparation method thereof includes the following steps of:
(1) uniformly mixing metallic oxide powder having a particle size of 2 to 100 nanometers and polyethylene glycol having a molecular weight of 1000 to 100000 at a mass ratio of 0.1 to 10 by ball-milling to obtain mixed powder of the metallic oxide and the polyethylene glycol;
(2) preparing slurry from the aforementioned powder with a solvent like water and ethanol or a combination thereof, stirring uniformly, and then drying the slurry to obtain a film or bulk on a substrate; and
(3) calcining the film or the bulk to remove organic compounds to obtain a film or bulk of a metallic oxide spherical cascade structure.

The metallic oxide is TiO₂, Fe₂O₃, Al₂O₃, SiO₂, SnO₂, etc.

Compared with the prior art, embodiments of the present invention have the following prominent advantages:
(1) The size of the spherical cascade structure may be controlled from hundreds of nanometers to tens of micrometers by controlling the mass ratio of the molecular weight of the polyethylene glycol to the metallic oxide.
(2) Since a dry milling method for preparing the metallic oxide spherical cascade structure does not need complex technologies such as the hydro-thermal synthesis, the hydrolysis and the atomic beam deposition, the cost is significantly reduced.
(3) The whole process needs a short period of time, is free of pollution, and suitable for mass and quick production.
(4) The process is easy in implementation, the requirements on equipment are low, and the cost is low.

### BRIEF DESCRIPTION

Some of the embodiments will be described in detail, with reference to the following figures, wherein like designations denote like members, wherein:

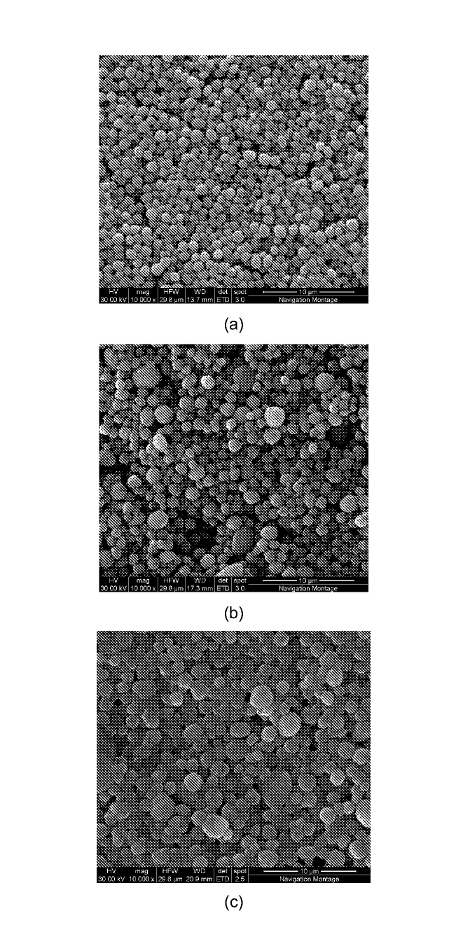

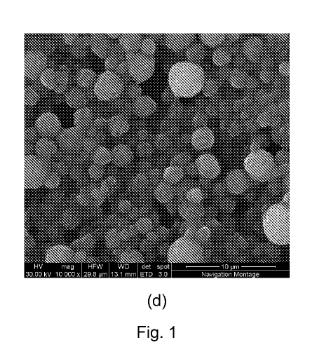

FIG. 1 is a scanning electron micrograph of a resulting titanium oxide spherical cascade structure when the mass ratio of the TiO₂ to the polyethylene glycol in the slurry is 3 g: 1 g and the molecular weight of the polyethylene glycol is different. FIGS. (a), (b), (c) and (d) represent the molecular weight of the polyethylene glycol is 20,000, 10,000, 4,000 and 2,000, respectively.

### DETAILED DESCRIPTION

### Embodiment 1

The TiO₂ powder having a particle size of 25 nanometers and polyethylene glycol having a molecular weight of 20,000 were mixed uniformly at a mass ratio of 3:1 by ball-mining to obtain mixed powder of TiO₂ and polyethylene glycol; a slurry was prepared by using water as a solvent, stirred uniformly, and applied onto a substrate by coating; and organic compounds were removed by calcining to obtain a film of a TiO₂ spherical cascade structure, as shown in FIG. 1(a).

### Embodiment 2

The TiO₂ powder having a particle size of 25 nanometers and polyethylene glycol having a molecular weight of 10,000 were mixed uniformly at a mass ratio of 3:1 by ball-mining to obtain mixed powder of TiO₂ and polyethylene glycol; a slurry was prepared by using ethanol as a solvent, stirred uniformly, and applied onto a substrate by coating to form a bulk; and organic compounds were removed by calcining to obtain a bulk of a TiO₂ spherical cascade structure, as shown in FIG. 1(b).

### Embodiment 3

The TiO₂ powder having a particle size of 25 nanometers and polyethylene glycol having a molecular weight of 4000 were mixed uniformly at a mass ratio of 3:1 by ball-mining to obtain mixed powder of TiO₂ and polyethylene glycol; a slurry was prepared by using water as a solvent, stirred uniformly, and applied onto a substrate by spin-coating to form a film; and organic compounds were removed by calcining to obtain a film of a TiO₂ spherical cascade structure, as shown in FIG. 1(c).

### Embodiment 4

The TiO₂ powder having a particle size of 25 nanometers and polyethylene glycol having a molecular weight of 2,000 were mixed uniformly at a mass ratio of 3:1 by ball-mining to obtain mixed powder of TiO₂ and polyethylene glycol; a slurry was prepared by using carbon tetrachloride as a solvent, stirred uniformly, and applied onto a substrate by coating; and organic compounds were removed by calcining to obtain a film of a TiO₂ spherical cascade structure, as shown in FIG. 1(d).

### Embodiment 5

The TiO₂ powder having a particle size of 100 nanometers and polyethylene glycol having a molecular weight of 1,000 were mixed uniformly at a mass ratio of 1:1 by ball-mining to obtain mixed powder of TiO₂ and polyethylene glycol; a slurry was prepared by using water as a solvent, stirred uniformly, and applied onto a substrate by coating; and organic compounds were removed by calcining to obtain a film of a TiO₂ spherical cascade structure.

### Embodiment 6

The TiO₂ powder having a particle size of 25 nanometers and polyethylene glycol having a molecular weight of 10,000 were mixed uniformly at a mass ratio of 1:1 by ball-mining to obtain mixed powder of TiO₂ and polyethylene glycol; a slurry was prepared by using carbon tetrachloride as a solvent, stirred uniformly, and applied onto a substrate by coating; and organic compounds were removed by calcining to obtain a film of a TiO₂ spherical cascade structure.

### Embodiment 7

The TiO₂ powder having a particle size of 50 nanometers and polyethylene glycol having a molecular weight of 20,000 were mixed uniformly at a mass ratio of 10:1 by ball-mining to obtain mixed powder of TiO₂ and polyethylene glycol; a slurry was prepared by using water as a solvent, stirred uniformly, and applied onto a substrate by spin-coating; and organic compounds were removed by calcining to obtain a film of a TiO₂ spherical cascade structure.

### Embodiment 8

The SnO₂ powder having a particle size of 30 nanometers and polyethylene glycol having a molecular weight of 20,000 were mixed uniformly at a mass ratio of 3:1 by ball-mining to obtain mixed powder of SnO₂ and polyethylene glycol; a slurry was prepared by using water as a solvent, stirred uniformly, and applied onto a substrate by coating; and organic compounds were removed by calcining to obtain a film of a SnO₂ spherical cascade structure.

Embodiment 9: The SiO₂ powder having a particle size of 25 nanometers and polyethylene glycol having a molecular weight of 20,000 were mixed uniformly at a mass ratio of 3:1 by ball-mining to obtain mixed powder of SiO₂ and polyethylene glycol; a slurry was prepared by using water as a solvent, stirred uniformly, and applied onto a substrate by spin-coating; and organic compounds were removed by calcining to obtain a film of a SiO₂ spherical cascade structure.

### Embodiment 10

The α-Fe₂O₃ powder having a particle size of 30 nanometers and polyethylene glycol having a molecular weight of 20,000 were mixed uniformly at a mass ratio of 3:1 by ball-mining to obtain mixed powder of α-Fe₂O₃ and polyethylene glycol; a slurry was prepared by using water as a solvent, stirred uniformly, and applied onto a substrate by coating to form a bulk; and organic compounds were removed by calcining to obtain a bulk of a α-Fe₂O₃ spherical cascade structure.

### Embodiment 11

The Al₂O₃ powder having a particle size of 50 nanometers and polyethylene glycol having a molecular weight of 20,000 were mixed uniformly at a mass ratio of 3:1 by ball-mining to obtain mixed powder of Al₂O₃ and polyethylene glycol; a slurry was prepared by using water as a solvent, stirred uniformly, and applied onto a substrate by coating; and organic compounds were removed by calcining to obtain a film of an Al₂O₃ spherical cascade structure.

1. A preparation method for a metallic oxide spherical cascade structure, comprising the following steps of:
(1) uniformly mixing a metallic oxide powder and polyethylene glycol by ball-milling to obtain a mixed powder of the metallic oxide and the polyethylene glycol;
(2) preparing a slurry from the aforementioned powder, stirring uniformly, and then drying the slurry to obtain a film or bulk on a substrate; and
(3) removing organic compounds by calcining to obtain a film or bulk of the metallic oxide spherical cascade structure.

2. The preparation method for a metallic oxide spherical cascade structure according to claim 1, wherein the spherical cascade structure refers to a micro-nano secondary structure which is a micron-sized spherical particle structure composed of metallic oxide powder having a particle size of 2 to 100 nanometers.

3. The preparation method for a metallic oxide spherical cascade structure according to claim 1, wherein the metallic oxide is TiO₂, Fe₂O₃, Al₂O₃, SiO₂ or SnO₂.

4. The preparation method for a metallic oxide spherical cascade structure according to claim 1, wherein, in the step (1), a molecular weight of the polyethylene glycol ranges from 1,000 to 100,000, and a mass ratio of the metallic oxide powder to the polyethylene glycol is from 0.1 to 10.

5. The preparation method for a metallic oxide spherical cascade structure according to claim 1 wherein, in the step (2), a solvent for preparing the slurry is water or ethanol or a combination thereof.
